(19) United States
(12) Patent Application Publication
(10) Pub. No.: US 2026/0153369 A1
(43) Pub. Date: Jun. 4, 2026

(54) FLOW METER WITH USE OF ULTRASOUND

(71) Applicant: SIKA Dr. Siebert & Kühn GmbH & Co. KG, Kaufungen (DE)

(72) Inventors: Armin Christian Welker, Edermünde/Grifte (DE); Lukas Osmar Schmidt, Kassel (DE); Bastian Wilke, Melsungen (DE)

(73) Assignee: SIKA Dr. Siebert & Kühn GmbH & Co. KG, Kaufungen (DE)

(21) Appl. No.: 19/400,538

(22) Filed: Nov. 25, 2025

(30) Foreign Application Priority Data
Nov. 29, 2024 (DE) 202024106930.7

(51) Int. Cl. G01F 1/66; G01F 1/667

(52) U.S. Cl. CPC G01F 1/662; G01F 1/667

(57) ABSTRACT

An ultrasonic flow meter includes a measuring tube through which a flow space extends and through which a flow medium can flow in at least one flow direction, a first ultrasonic transducer is arranged at a first position, at least one second ultrasonic transducer or at least one reflection surface are arranged at a second position in order to transmit an ultrasonic wave into the flow space and to receive the transmitted ultrasonic wave from the respective other ultrasonic transducer or the reflection surface to form an ultrasonic propagation path, and an inner wall segment is arranged in the measuring tube on which the emitted ultrasonic wave impinges and reflects. The ultrasonic propagation path has sections perpendicular and transverse to the flow direction.

### CROSS-REFERENCE TO RELATED APPLICATION

This application claims priority to German Patent Application No. 20 2024 106 930.7 filed on 29 Nov. 29, 2024, which is herein incorporated by reference in its entirety.

### TECHNICAL FIELD

The present disclosure relates to an ultrasonic flow meter with a measuring tube through which a flow space extends and through which a flow medium can flow in at least one flow direction, wherein a first ultrasonic transducer is arranged at a first position and at least one second ultrasonic transducer or at least one reflection surface is arranged at a second position in order to transmit an ultrasonic wave into the flow space and to receive the transmitted ultrasonic wave back from the other ultrasonic transducer or reflected from the reflection surface, forming an ultrasonic propagation path, and wherein an inner wall segment is arranged in the measuring tube, on which the transmitted ultrasonic wave strikes and is reflected.

### BACKGROUND

DE 10 2006 019 146 B3 discloses an ultrasonic flow meter with a measuring tube through which a flow space extends, through which a flow medium flows, wherein a first ultrasonic transducer is arranged at a first position and a second ultrasonic transducer is arranged at a second position so as to transmit an ultrasonic wave into the flow space and to receive the transmitted ultrasonic wave back from the other ultrasonic transducer.

The ultrasonic sensors are arranged at an angle on the measuring tube in order to generate the oblique path of the ultrasonic wave through the measuring tube. The ultrasonic wave can be emitted by the first ultrasonic transducer and received by the second ultrasonic transducer and vice versa. If a flow medium flows along the longitudinal axis through the flow space of the measuring tube, the flow medium transports the ultrasonic wave with the flow to the receiving ultrasonic transducer faster than if the sound propagates against the direction of flow. The resulting time differences can be evaluated by an evaluation electronics system to determine the flow velocity of the flow medium in the flow chamber of the measuring tube.

Unfortunately, there are disadvantages associated with positioning the two ultrasonic transducers at an angle to the longitudinal axis on the outside of the measuring tube, as the ultrasound must penetrate the tube wall.

EP 3 800 448 B1 discloses a further embodiment of an ultrasonic flow meter, with a measuring tube through which an flow space extends, through which a flow medium can flow, wherein a first ultrasonic transducer is arranged at a first position and a second ultrasonic transducer is arranged at a second position such that a W-shaped wave propagation of the ultrasonic wave is created between the ultrasonic transducers. In order to influence the propagation of the ultrasonic wave in the flow channel, a flow restriction element is provided, which is arranged between two of a total of three reflectors; wherein the flow restriction element comprises a first wedge with a first sloping surface, and wherein a first wedge has a first plurality of teeth protruding from the first sloping surface, wherein the flow channel has an outlet opening, and wherein the flow channel comprises an inlet opening, wherein the inlet opening is disposed opposite the outlet opening and a fluid path extends from the inlet opening to the outlet opening, wherein the three reflectors comprise a first reflector, wherein the first reflector is disposed closest to the outlet opening among the three reflectors; wherein the three reflectors comprise a second reflector, wherein the second reflector is disposed closest to the inlet opening among the three reflectors, wherein the flow restriction element is inserted between the first reflector and the second reflector, wherein the flow channel comprises a fourth wedge having a fourth inclined surface, wherein the fourth wedge has at least one tooth protruding from the fourth inclined surface, and wherein the fourth wedge is arranged between the second reflector and the inlet opening. The flow restriction element in particular greatly narrows the remaining flow cross-section, resulting in pressure losses in the flow meter.

Ultrasonic flow meters are among the most accurate and versatile instruments for measuring the flow of liquids and gases. They utilize the property of ultrasonic waves to travel through different media at characteristic speeds, whereby these speeds are influenced by the flow velocity of the medium.

The basic principle of ultrasonic flow measurement is based on three main methods: In the time-of-flight method, two ultrasonic transducers send and receive signals along and against the direction of flow, with the time difference being used to calculate the flow velocity. The Doppler method, on the other hand, measures frequency changes in ultrasonic waves reflected by particles or gas bubbles in the medium and is therefore particularly suitable for media containing particles or air bubbles. The cross-correlation method analyses the delay between correlated signals from different transducers, making it ideal for uneven flows.

Technological aspects such as multipath technology and clamp-on ultrasonic measurement significantly expand the application possibilities of these devices. Multipath technology uses multiple ultrasonic paths to compensate for irregularities in the flow, such as turbulence or asymmetrical profiles, thereby increasing measurement accuracy. Clamp-on technology allows the ultrasonic transducers to be attached to pipes from the outside using retaining elements, making them ideal for applications where intervention in the pipe system is undesirable.

Clamp-on ultrasonic measurement typically works according to the transit time principle. Sound waves are sent through the pipe wall into the medium, reflected by the opposite pipe wall and then measured. The transit time difference between waves travelling in the direction of flow and against the flow is used to calculate the flow velocity. Compared to inline measurements, where sensors are positioned directly in the medium and thus provide very accurate results, the clamp-on method is non-contact and avoids interference with the pipe system. However, it does present challenges such as signal loss due to reflections at interfaces.

Plug-in solutions represent a hybrid between invasive inline devices and non-contact clamp-on systems. They require sensors to be inserted into the pipeline through special openings or valves, giving them direct contact with the medium. This offers the aspects of less invasive installation compared to inline devices but also presents specific challenges. Geometric changes in the pipe wall caused by insertion sensors can create cavities and dead water zones, which cause flow disturbances, deposits and inaccuracies. Pressure losses are caused by flow resistance and turbulence, which occur particularly with poorly positioned or non-aerodynamically shaped sensors.

Clamp-on technology also has specific disadvantages, such as the problem of structure-borne noise. Ultrasonic waves can also travel through the pipe wall, leading to unwanted interference. Reflections at interfaces caused by differences in acoustic impedance and air pockets that weaken or scatter sound waves are further challenges. At typical frequencies between 1 MHz and 10 MHz, even small air pockets can cause significant signal loss.

Optimizations such as the use of high-quality coupling materials, frequency matching and advanced signal processing can help to minimize these disadvantages. Overall, clamp-on ultrasonic measurement offers a flexible and non-contact solution for flow measurements, especially in applications where hygienic or operational requirements prohibit the opening of the pipe system.

Ultrasonic flow meters are widely used in industry, including water supply, energy, chemical and petrochemical, and food and beverage. Nevertheless, challenges remain, such as accuracy with difficult media, sensitivity to flow profiles, and adaptation to extreme operating conditions. Future developments will focus on miniaturizing the sensor technology, expanding the measurement capabilities for heterogeneous media, and improving energy efficiency and robustness.

EP 1 096 236 A2 and DE 39 41 544 A1 disclose ultrasonic flow meters with ultrasonic waves emitted into the flow space at an angle to the longitudinal axis. The sound waves can be emitted directly into the flow medium, but this has the disadvantage of creating dead water zones in front of the ultrasonic transducers, which have a negative effect on the flow of the flow medium.

### SUMMARY

The task of the present disclosure is therefore to create an ultrasonic flow meter that is simple in design and enables the smallest possible flow resistance for the flow medium flowing through the measuring tube. In particular, the present disclosure aims to minimize the pressure loss in insertion sensors. Ideally, the flow meter should only exhibit a pressure loss corresponding to the pipe section of its nominal diameter.

This task is solved on the basis of an ultrasonic flow meter according to the present disclosure.

The present disclosure includes the technical teaching that the ultrasonic propagation path has sections perpendicular and transverse to the direction of flow.

The solution to the problem is initially a clever choice of the ultrasonic propagation path, because the sections perpendicular and transverse to the direction of flow form an M shape and not a W shape. The M shape is shown as a line in FIGS. 2 to 4. Strictly speaking, it is an inverted, upside-down M as shown in the illustration.

The M-shape has several aspects: The sensor faces are largely form-fitting with the inner wall of the pipe, so that they do not deviate significantly from the inner wall contour of the rest of the measuring pipe, minimizing the areas of dead water in cavities and protrusions.

Another aspects is that the M-shape allows for measuring sections perpendicular to the flow, which makes it possible to measure the sound velocity of the fluid, which is particularly dependent on temperature and purity.

The present disclosure thus relates to an ultrasonic flow meter with a measuring tube through which a flow space extends and through which a flow medium can flow in a flow direction, wherein a first ultrasonic transducer is arranged at a first position and at least one second ultrasonic transducer or at least one reflection surface is arranged at a second position in order to transmit an ultrasonic wave into the flow space and to receive the transmitted ultrasonic wave back from the other ultrasonic transducer or the reflection surface, forming an ultrasonic propagation path, and wherein an inner wall segment is arranged in the measuring tube, on which the emitted ultrasonic wave strikes and is reflected, wherein the ultrasonic propagation path has sections perpendicular and transverse to the direction of flow.

The ultrasonic propagation path is M-shaped, with an inner “V” section of the M-shape running at an angle to the direction of flow and outer I-sections of the M-shape running perpendicular to the direction of flow.

At least one or more inner wall segments can form at least one or more cavities which are at least partially or completely covered by form-fitting cover surfaces for separating the fluid in the flow space and the ultrasonic transducer and which each separate a space volume within the cavity from the flow space in terms of fluid mechanics.

Furthermore, it is provided that the cover surfaces are formed from a membrane which allows the cavity space volume to be filled with the flow medium flowing through the flow space.

The membrane can form a surface body with openings and/or perforations and/or be designed like a sieve. Alternatively, at least one small tube may be provided for ventilating the cavity, each of which connects the space volume to the flow medium inside the tube. In embodiments, two small tubes are provided, which are located one behind the other in the direction of flow, so that a constant exchange of fluid in the cavity is possible despite a substantially closed cover surface.

Alternatively, the space volume can be filled with a sealing compound, and the cover surface can be formed from the sealing compound. The sealing compound can have the same or similar sound velocity characteristics as the flow medium.

The flow medium may be a gas or a liquid. It is also conceivable that the flow medium is a phase mixture and/or has gaseous, liquid and/or solid components. The flow medium may, for example, be formed at least in part by H2O.

The casting compound may behave like polyurethane and/or like “aptflex f7” and/or contain these substances.

It is also conceivable that the thickness of the membrane corresponds to half the wavelength of the sound in the membrane material or an integer multiple thereof. This represents the possibility that the membrane becomes particularly permeable to the sound of the frequency used. This achieves a lambda/2 line, which ensures that the membrane's characteristic impedance is virtually no longer apparent and thus becomes acoustically transparent.

### BRIEF DESCRIPTION OF THE DRAWINGS

Further measures for improving the present disclosure are described in more detail below, together with a description of embodiments of the present disclosure, with reference to the figures. It shows:

FIG. 1 an ultrasonic flow meter with two ultrasonic transducers arranged on the outside of the measuring tube,

FIG. 2 an ultrasonic flow meter with ultrasonic transducers that transmit and receive vertically to create an M-shape in the ultrasonic propagation path, with two cavities incorporated into the inner contour of the measuring tube,

FIG. 3 an ultrasonic flow meter with two cavities in the inner contour of the measuring tube, which are filled with a casting compound, and

FIG. 4 an ultrasonic flow meter with two cavities in the inner contour of the measuring tube, which are covered with a membrane that is permeable to sound and fluids.

### DETAILED DESCRIPTION

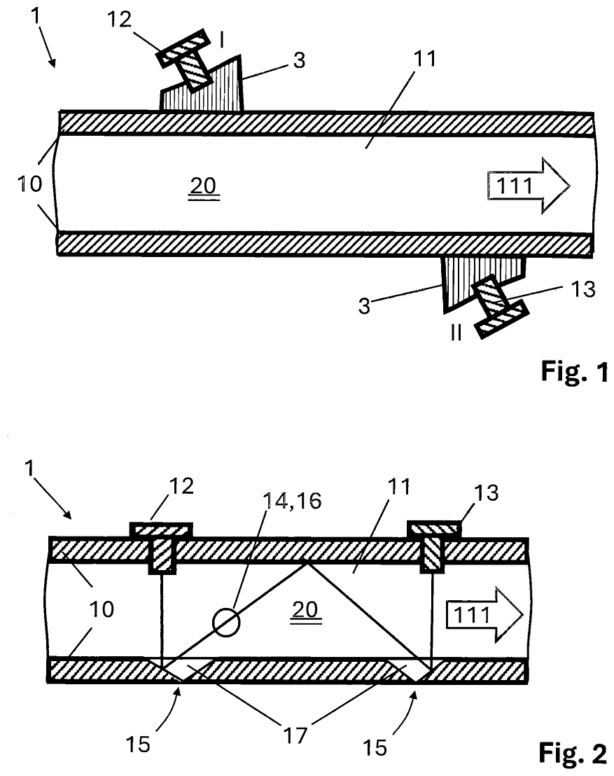

FIG. 1, as well as FIGS. 2, 3 and 4, shows an ultrasonic flow meter 1 with a measuring tube 10 through which a flow space 11 extends and through which a flow medium 20 can flow in a flow direction 111, wherein a first ultrasonic transducer 12 is arranged at a first position I and at least one second ultrasonic transducer 13 or at least one reflection surface is arranged at a second position II in order to emit an ultrasonic wave 14 into the flow space 11 and to receive the emitted ultrasonic wave 14 from the respective other ultrasonic transducer 12, 13 or the reflection surface to form an ultrasonic propagation path 16, and wherein an inner wall segment 15 is arranged in the measuring tube 10, on which the emitted ultrasonic wave 14 strikes and is reflected, see in particular FIGS. 2 to 4. The ultrasonic transducers 12, 13 according to FIG. 1 are attached to the outside of the measuring tube 10 by retaining elements 3, so that oblique incidence of the ultrasonic wave is possible, which is state of the art.

As shown in FIG. 2, large cavities 17 in front of the reflectors at the tips of the M-shape would be disadvantageous. According to the present disclosure, these are removed from the flow dynamics by cover surfaces 18, 19.

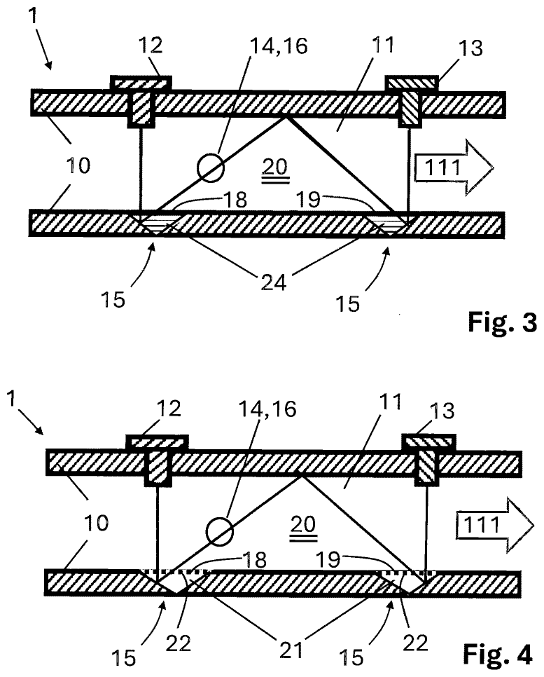

As shown in FIG. 3 and FIG. 4, the cover surfaces 18, 19 are positively connected to the inner wall of the tube. Consequently, the flow medium 20 experiences an almost normal tube section with a simply continued inner wall of the tube.

There are now two options for filling the cavities: Firstly, the cavity can be filled with a casting compound 24 with a characteristic ultrasonic propagation velocity comparable to the characteristic propagation velocity in the flow medium 20. In particular, the casting compound “AptFlex F7” may be suitable, as it exhibits similar acoustic behavior to conventional flow media that contains water or are similar to water. On the other hand, the space behind the cover surface 18, 19 can be filled by the flowing fluid. This means that the ultrasonic propagation velocity is generally the same, whereby perforations in the membrane 22 can be designed in such a way that fluid exchange can still take place in the space volume 21 of the cavity, i.e. behind the membrane.

AptFlex F7 is a special polyurethane-based potting compound that is frequently used in ultrasonic technology. It is provided by Precision Acoustics Ltd and is primarily used as an acoustically optimized material for applications requiring low attenuation and good acoustic impedance matching.

AptFlex F7 has low acoustic attenuation. This ensures high signal quality and low losses during the transmission of ultrasonic waves. It also provides good acoustic impedance matching, which is particularly important for minimizing reflections at interfaces. It is also a flexible and durable material, making it particularly suitable for use in robust and variable environments.

AptFlex F7 is also easy to process. It is supplied in liquid form and hardens into a flexible, solid material. AptFlex F7 is used for encapsulating and protecting ultrasonic sensors. AptFlex F7 is often used to protect ultrasonic sensors from mechanical damage, moisture and other environmental factors. In addition, AptFlex F7 can serve as an acoustic coupling medium, particularly in the manufacture of ultrasonic arrays or acoustic elements. In research and development, AptFlex F7 can be used in ultrasonic technology and related fields to enable precise measurements.

The present disclosure is not limited in its execution to the embodiment described above. Rather, a number of variants are conceivable which make use of the solution described, even in fundamentally different embodiments. All features and/or aspects arising from the claims, the description or the drawings, including design details or spatial arrangements, form the present disclosure both individually and in various combinations.

### LIST OF REFERENCE SIGNS

1 Ultrasonic flow meter
3 Retaining element
10 Measuring tube
11 Flow chamber
12 Ultrasonic transducer
13 Ultrasonic transducer
14 Ultrasonic wave
15 Inner wall segment
16 Ultrasonic propagation path
16a Vertical distance
16b Transverse distance
17 Cavity
18 Cover area
19 Cover area
20 Flow medium
21 Room volume
22 Membrane
23 Tube
24 Sealing compound
111 Flow direction

1. An ultrasonic flow meter comprising:
a measuring tube through which a flow space extends and through which a flow medium can flow in at least one flow direction,
a first ultrasonic transducer is arranged at a first position,
at least one second ultrasonic transducer or at least one reflection surface are arranged at a second position in order to transmit an ultrasonic wave into the flow space and to receive the transmitted ultrasonic wave from the respective first ultrasonic transducer or the reflection surface to form an ultrasonic propagation path, and
an inner wall segment is arranged in the measuring tube on which the emitted ultrasonic wave impinges and reflects,
wherein the ultrasonic propagation path has sections perpendicular and transverse to the flow direction.

2. The ultrasonic flow meter according to claim 1, wherein the ultrasonic propagation path is M-shaped, wherein an inner “V”-section of the M-shape is formed at an angle to the flow direction and outer I-sections of the M-shape are formed perpendicular to the flow direction.

3. The ultrasonic flow meter according to claim 1, wherein at least one or more of the inner wall segments form cavities which, for the purpose of separating the flow medium in the flow space, the first ultrasonic transducer, and the second ultrasonic transducer by form-fitting cover surfaces covering the cavities partly or entirely and each separate a space volume within the cavity from the flow space in terms of fluid mechanics.

4. The ultrasonic flow meter according to claim 3, wherein the cover surfaces are formed from a membrane which allows the space volume of the cavities to be filled with the flow medium flowing through the flow space.

5. The ultrasonic flow meter according to claim 4, wherein the membrane forms a surface body with openings and/or perforations and/or which the surface body is designed like a sieve.

6. The ultrasonic flow meter according to claim 3, wherein at least one capillary tube is provided which connects each of the space volumes to the flow medium (20) inside the measuring tube.

7. The ultrasonic flow meter according to claim 3, wherein the space volume is filled with a sealing compound and the cover surfaces are formed from the sealing compound.

8. The ultrasonic flow meter according to claim 7, wherein the sealing compound has the same or a similar sound velocity characteristic as the flow medium.

9. The ultrasonic flow meter according to claim 1, wherein the flow medium is a gas.

10. The ultrasonic flow meter according to claim 1, wherein the flow medium is a liquid.

11. The ultrasonic flow meter according to claim 1, wherein the flow medium is a phase mixture and/or has gaseous, liquid and/or solid components.

12. The ultrasonic flow meter according to claim 1, wherein the flow medium is at least partially formed by H2O.

13. The ultrasonic flow meter according to claim 7, wherein the sealing compound behaves like polyurethane and/or like “AptFlex F7” and/or contains components thereof or consists thereof.

14. The ultrasonic flow meter according to claim 4, wherein a thickness of the membrane corresponds to half a wavelength of a sound in a material of the membrane or an integer multiple thereof.
